(19) United States
(12) Patent Application Publication
(10) Pub. No.: US 2019/0340780 A1
(43) Pub. Date: Nov. 7, 2019

(54) ENGAGEMENT VALUE PROCESSING SYSTEM AND ENGAGEMENT VALUE PROCESSING APPARATUS

(71) Applicant: GAIA SYSTEM SOLUTIONS INC., Tokyo (JP)

(72) Inventors: Ryuichi HIRAIDE, Tokyo (JP); Masami MURAYAMA, Tokyo (JP); Shouichi HACHIYA, Tokyo (JP); Seiichi NISHIO, Tokyo (JP); Mikio OKAZAKI, Tokyo (JP)

(21) Appl. No.: 16/311,025

(22) PCT Filed: May 2, 2017
(86) PCT No.: PCT/JP2017/017260

§ 371 Date: Feb. 28, 2019

(30) Foreign Application Priority Data
Jun. 23, 2016 (JP) 2016-124611

(51) Int. Cl. G06T 7/70; G06T 7/00; G06F 3/01; G06K 9/00

(52) U.S. Cl. CPC G06T 7/70; G06T 7/0012; G06F 3/012; G06F 2203/011; G06K 9/00281; G06K 9/00228; G06T 2207/30201; G06F 3/015

(57) ABSTRACT

An engagement value processing system is provided which can simultaneously acquire biological information such as a pulse in addition to an engagement value by using only video data obtained from an imaging apparatus. In an image data stream outputted by the imaging apparatus, feature data indicating features of a face is generated by a feature extraction unit. A face direction vector and a line-of-sight direction vector for calculating an engagement value of a user for a content are calculated from the feature data. On the other hand, the feature data can also be used to cut out partial image data for detecting a pulse and estimate the emotion of the user. Therefore, the engagement value for the content, the pulse, and the emotion of the user viewing the content can be simultaneously acquired simply by capturing the user with the imaging apparatus.

### TECHNICAL FIELD

The present invention relates to an engagement value processing system and an engagement value processing apparatus, which detect and use information on an engagement value presented by a user to a content provided to the user by a computer, an electronic device, or the like, for the content.

### BACKGROUND ART

A “household audience rating” is conventionally used as an index indicating the percentage of the viewers viewing a video content broadcast in television broadcasting (hereinafter “TV broadcasting”). In the measurement of a household audience rating in TV broadcasting, a device for measuring an audience rating is installed in a house being a sample, and the device transmits information on the channel displayed on a television set (hereinafter a “TV”) in an on state almost in real time to a counting location. In other words, the household audience rating is a result of the count of information on a viewing time and a viewing channel, and the state in which viewers viewed a program (a video content) is unknown from the information that is the household audience rating.

For example, in a case of a viewing form in which a viewer is not focusing attention on a TV program on the screen and is letting it go in one ear and out the other like a radio, the program is not being viewed in a state where the viewer is concentrating on the program. In such a viewing form, an advertisement effect of a commercial (hereinafter a “CM”) running during the TV program is not very promising.

Some technologies for finding to what degree a viewer is concentrating on and viewing a TV program are being studied.

Patent Document 1 discloses a technology in which to what degree a viewer is concentrating on a TV program is defined as the “degree of concentration”, and the degree of concentration is learned and used.

Patent Document 2 discloses a technology for detecting a pulse from image data of the face of a user captured with a camera, using the short-time Fourier transform (short-time Fourier Transform, short-term Fourier Transform, STFT).

Patent Document 3 discloses a technology for detecting a pulse using the discrete wavelet transform (Discrete wavelet transform, DWT).

### CITATION LIST

### Patent Literature

Patent Document 1: JP-A-2003-111106

Patent Document 2: JP-A-2015-116368

Patent Document 3: JP-A-10-216096

### SUMMARY OF THE INVENTION

### Problems to be Solved by the Invention

As illustrated in Patent Document 3 described above, a target content (contents) related to the degree of concentration of a viewer is not necessarily limited to a TV program. Any content can be a target. Here, a content collectively indicates information that a target person enjoys with an understandable content, such as character strings, audio, still images, video (moving images), which are presented online or offline through a computer or an electronic device, or a presentation or game of a combination thereof. Moreover, a person who enjoys and/or uses a content is hereinafter generally called not a viewer but a user in the description.

The inventors have developed devices that measure the degree of concentration. In the course of the development of the devices, the inventors realized that there are not only active factors but also passive factors in a state where a person concentrates on a certain event.

For example, a person's act of concentrating on the solution of a certain issue in the face of the issue is an active factor. In other words, the act is triggered by thinking that “the person needs to concentrate on the event.” In contrast, a person's act of looking at an interesting or funny event and becoming interested in the event is a passive factor in a sense. In other words, the act is triggered by an emotion of “being intrigued by the event without thought.”

The inventors thought that it was not necessarily appropriate to express such acts triggered by the contradicting thought and emotion in the term “degree of concentration.” Hence, the inventors decided to define a state where a target person focuses attention on a certain event regardless of an active or passive factor, as a term “engagement (Engagement),” The inventors defined the devices that they have developed as not devices that measure the degree of concentration but devices that measure engagement.

Especially many of the highly entertaining video contents have an effect of arousing various emotions of a user. If in addition to an engagement value, biological information for detecting the emotion of a user can be simultaneously acquired, the biological information becomes useful information that can be used to evaluate and improve a content.

Moreover, contents viewed by users are not necessarily limited to contents targeted for entertainment. There are also contents used for education, study, and the like at after-hours cram schools and the like. In contents used for the purpose of education, study, and the like, the engagement value is an important content evaluation index. Effective study cannot be expected in a case of contents that do not receive attention of users.

The present invention has been made considering such problems, and an object thereof is to provide an engagement value processing system and an engagement value processing apparatus, which can simultaneously acquire biological information such as a pulse in addition to an engagement value, using only video data obtained from an imaging apparatus.

### Solutions to the Problems

In order to solve the above problems, an engagement value processing system of the present invention includes: a display unit configured to display a content; an imaging apparatus installed in a direction of being capable of capturing the face of a user who is watching the display unit; a face detection processing unit configured to detect the presence of the face of the user from an image data stream outputted from the imaging apparatus and output extracted face image data obtained by extracting the face of the user; a feature extraction unit configured to output, on the basis of the extracted face image data, feature data being an aggregate of features having coordinate information in a two-dimensional space, the features including a contour of the face of the user; a vector analysis unit configured to generate, on the basis of the feature data, a face direction vector indicating a direction of the face of the user and a line-of-sight direction vector indicating a direction of the line of sight on the face of the user at a predetermined sampling rate; and an engagement calculation unit configured to calculate an engagement value of the user for the content from the face direction vector and the line-of-sight direction vector.

Furthermore, included is a database configured to accumulate a user ID that uniquely identifies the user, a viewing date and time when the user views the content, a content ID that uniquely identifies the content, playback position information indicating a playback position of the content, and the engagement value of the user for the content outputted by the engagement calculation unit.

### Effects of the Invention

The present invention allows simultaneously acquiring biological information such as a pulse in addition to an engagement value, using only video data obtained from an imaging apparatus.

Problems, configurations, and effects other than the above ones will be clarified from a description of the following embodiments.

### BRIEF DESCRIPTION OF THE DRAWINGS

FIG. 1 is a schematic diagram illustrating a general picture of an engagement value processing system according to embodiments of the present invention.

FIGS. 2A and 2B are schematic diagrams explaining the mechanism of an engagement value of a user in the engagement value processing system according to the embodiments of the present invention.

FIGS. 3A to 3C are diagrams illustrating types of display and varieties of camera.

FIGS. 4A and 4B are diagrams illustrating areas of the most suitable positions of a camera for a landscape and a portrait display.

FIG. 5 is a block diagram illustrating the hardware configuration of the engagement value processing system.

FIG. 6 is a block diagram illustrating the software functions of an engagement value processing system according to a first embodiment of the present invention.

FIG. 7 is a functional block diagram of an engagement calculation unit.

FIG. 8 is a block diagram illustrating the software functions of an engagement value processing system according to a second embodiment of the present invention.

FIGS. 9A to 9C are a schematic diagram illustrating an example of an image data stream outputted from an imaging apparatus, a schematic diagram illustrating an example of extracted face image data outputted by a face detection processing unit, and a schematic diagram illustrating an example of feature data outputted by a feature extraction unit.

FIG. 10 is a diagram schematically illustrating areas cut out as partial image data by a pulse detection area extraction unit from image data of a user's face.

FIG. 11 is a schematic diagram explaining emotion classification performed by an emotion estimation unit.

FIG. 12 is a block diagram illustrating the hardware configuration of an engagement value processing apparatus according to a third embodiment of the present invention.

FIG. 13 is a block diagram illustrating the software functions of the engagement value processing apparatus according to the third embodiment of the present invention.

FIG. 14 is a graph illustrating an example of the correspondence between the engagement value and the playback speed of a content generated by control information provided by a playback control unit to a content playback processing unit.

### DESCRIPTION OF PREFERRED EMBODIMENTS

An engagement value processing system according to embodiments of the present invention measures an engagement value of a user for a content, uploads the engagement value to a server, and uses the engagement value for various analyses and the like.

Generally, the engagement value processing system captures a user's face with a camera, detects the directions of the user's face and line of sight, measures to what degree these directions point at a display where a content is displayed, and accordingly calculates the user's engagement value for the content.

On the other hand, as illustrated in Patent Document 2, a technology for detecting a pulse from image data of a user's face captured with a camera is known. However, in order to detect a pulse from the face image data, extracting an appropriate area to detect a pulse from the face image data is required as a precondition. In the engagement value processing system according to the embodiments of the present invention, an appropriate area to detect a pulse is extracted on the basis of vector data indicating the contour of a user's face, the vector data being acquired to measure the engagement value.

In the engagement value processing system in the embodiments of the present invention, contents using the sense of sight are targeted. Therefore, audio-only contents are outside the scope of measurement and use of the engagement value in the engagement value processing system according to the embodiments of the present invention.

### [Entire Configuration]

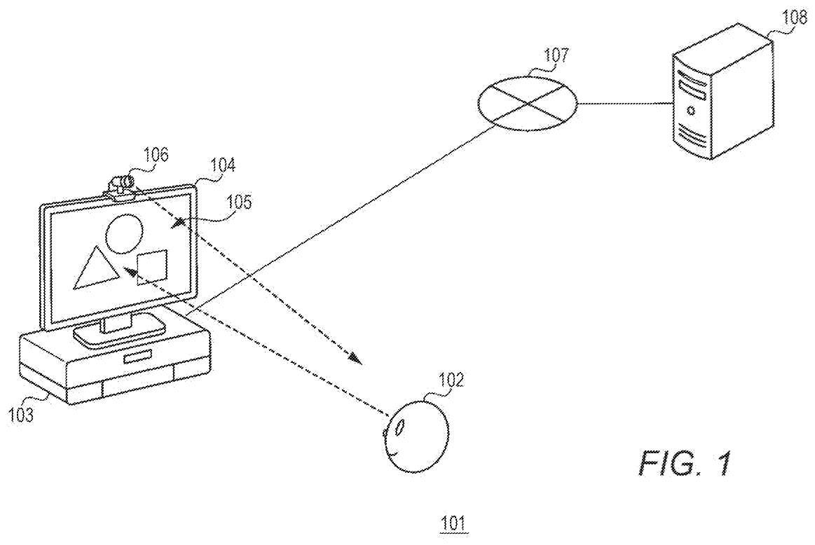

FIG. 1 is a schematic diagram illustrating a general picture of an engagement value processing system 101 according to the embodiments of the present invention.

A user 102 views a content 105 displayed on a display unit 104 of a client 103 having a content playback function. An imaging apparatus 106, what is called a web camera, is provided on a top part of the display unit 104 configured by a liquid crystal display or the like. The imaging apparatus 106 captures the face of the user 102 and outputs an image data stream.

The client 103 includes an engagement value processing function therein. Various types of information including the engagement value of the user 102 for the content 105 are calculated by the engagement value processing function of the client 103 to be uploaded to a server 108 through the Internet 107.

### [Regarding Engagement Value]

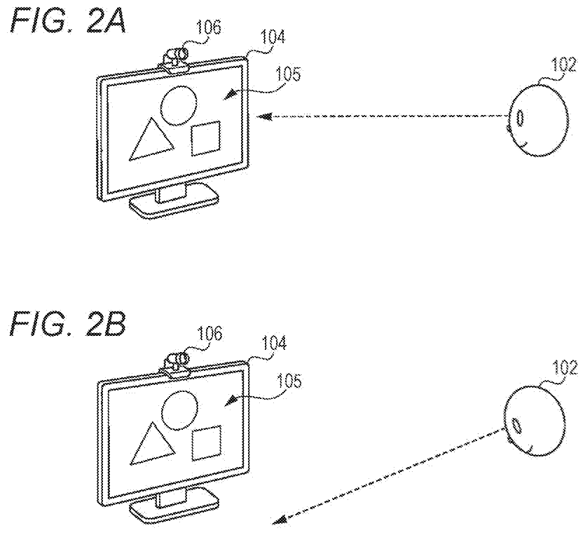

FIGS. 2A and 2B are schematic diagrams explaining the mechanism of the engagement value of the user 102 in the engagement value processing system 101 according to the embodiments of the present invention.

In FIG. 2A, the user 102 is focusing attention on the display unit 104 where the content 105 is being displayed. The imaging apparatus 106 is mounted on top of the display unit 104. The imaging apparatus 106 is oriented in a direction where the face of the user 102 in front of the display unit 104 can be captured. The client 103 (refer to FIG. 1) being an unillustrated information processing apparatus is connected to the imaging apparatus 106. The client 103 detects whether or not the directions of the face and/or line of sight of the user 102 point in the direction of the display unit 104, from image data obtained from the imaging apparatus 106, and outputs whether or not the user 102 is focusing attention on the content 105 as data of a value within a predetermined range of, for example, 0 to 1, or 0 to 255, or 0 to 1023. The value outputted from the client 103 is an engagement value.

In FIG. 2B, the user 102 is not focusing attention on the display unit 104 where the content 105 is being displayed. The client 103 connected to the imaging apparatus 106 outputs a lower engagement value than the engagement value of FIG. 2A on the basis of image data obtained from the imaging apparatus 106.

In this manner, the engagement value processing system 101 according to the embodiments is configured to be capable of calculating whether or not the directions of the face and/or line of sight of the user 102 point at the display unit 104 where the content 105 is being displayed, from image data obtained from the imaging apparatus 106.

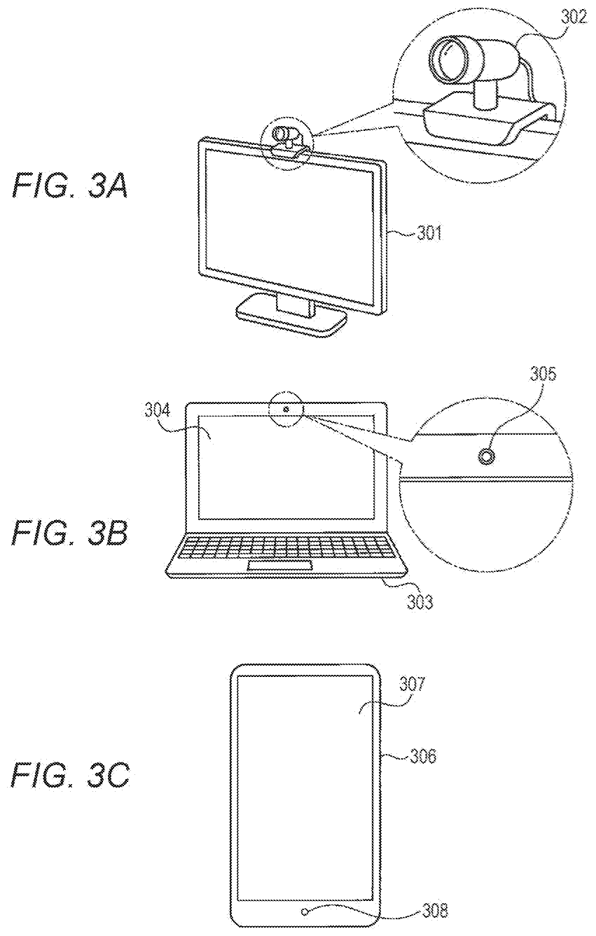

FIGS. 3A, 3B, and 3C are diagrams illustrating types of the display unit 104 and varieties of the imaging apparatus 106.

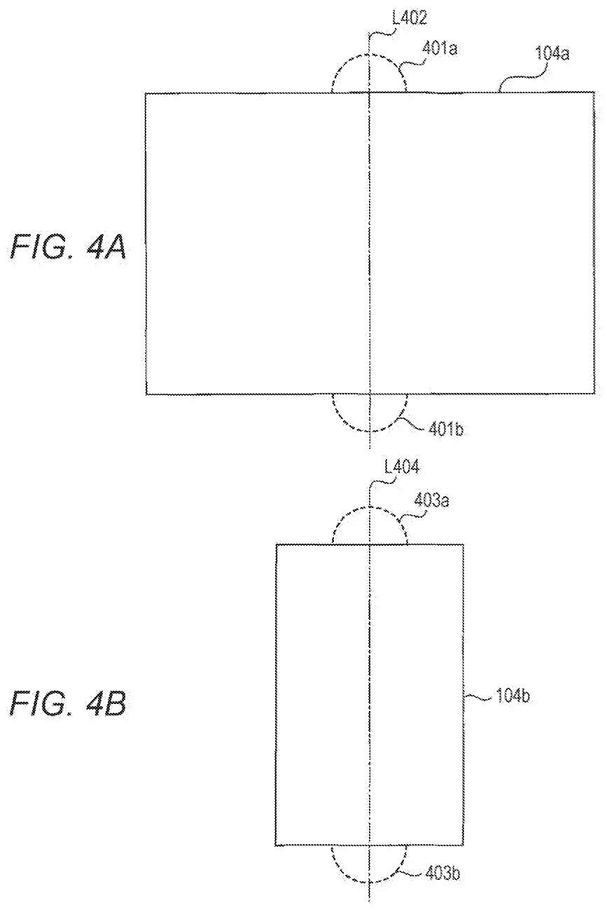

FIGS. 4A and 4B are diagrams illustrating the types of the display unit 104 and the relationship of placement where the imaging apparatus 106 is mounted.

FIG. 3A is an example where an external USB web camera 302 is mounted on a stationary LCD display 301.

FIG. 3B is an example where a web camera 305 is embedded in a frame of an LCD display 304 of a notebook personal computer 303.

FIG. 3C is an example where a selfie front camera 308 is embedded in a frame of an LCD display 307 of a wireless mobile terminal 306 such as a smartphone.

A common point to FIGS. 3A, 3B, and 3C is a point that the imaging apparatus 106 is provided near the center line of the display unit 104.

FIG. 4A is a diagram corresponding to FIGS. 3A and 3B and illustrating areas of the most suitable placement positions of the imaging apparatus 106 in a landscape display unit 104a.

FIG. 4B is a diagram corresponding to FIG. 3C and illustrating areas of the most suitable placement positions of the imaging apparatus 106 in a portrait display unit 104b.

In both of cases of the display unit 104a of FIG. 4A and the display unit 104b of FIG. 4B, that is, cases where the display is of the landscape type and of the portrait type, as long as the imaging apparatus 106 is placed in any of areas 401a, 401b, 403a, and 403b, through which center lines L402 and L404 pass, on upper and lower sides of the display units 104a and 104b, the imaging apparatus 106 can capture the face and line of sight of the user 102 correctly without any adjustments.

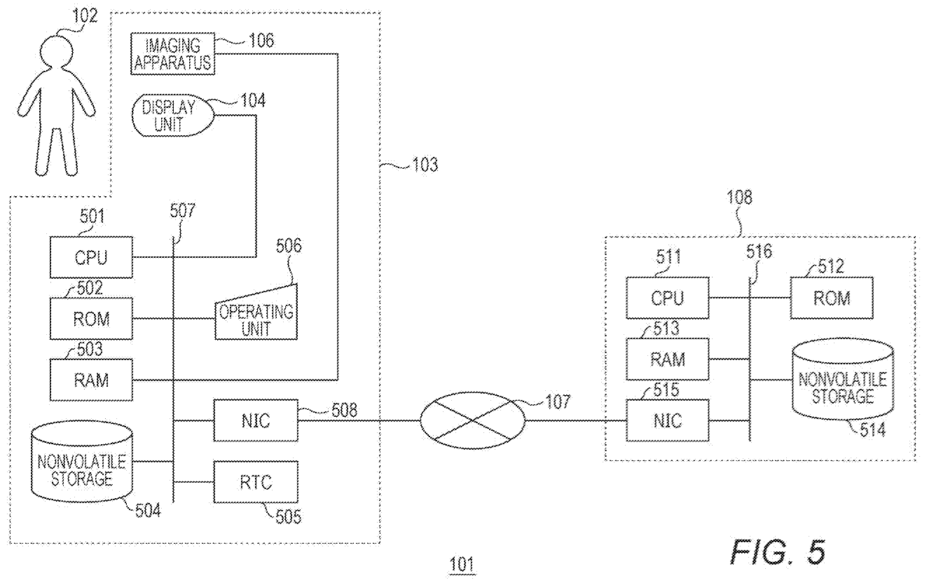

If the imaging apparatus 106 is installed at a position outside these areas, it is preferable to previously detect information on the directions of the face and line of sight of the user 102, as viewed from the imaging apparatus 106, of when the face and line of sight of the user 102 point correctly at the display unit 104 and store the information in, for example, a nonvolatile storage 504 (refer to FIG. 5) in order to detect whether or not the face and line of sight of the user 102 are pointing correctly at the display unit 104.

### [Engagement Value Processing System 101: Hardware Configuration]

FIG. 5 is a block diagram illustrating the hardware configuration of the engagement value processing system 101.

The client 103 is a general computer. A CPU 501, a ROM 502, a RAM 503, the nonvolatile storage 504, a real time clock (hereinafter “RTC”) 505 that outputs current date and time information, and an operating unit 506 are connected to a bus 507. The display unit 104 and the imaging apparatus 106, which play important roles in the engagement value processing system 101, are also connected to the bus 507. The client 103 communicates with the server 108 via the Internet 107 through an NIC (Network Interface Card) 508 connected to the bus 507.

The server 108 is also a general computer. A CPU 511, a ROM 512, a RAM 513, a nonvolatile storage 514, and an NIC 515 are connected to a bus 516.

### First Embodiment: Software Functions of Engagement Value Processing System 101

Next, a description is given of the software functions of the engagement value processing system 101. Most of the functions of the engagement value processing system 101 are configured by software functions. Part of the software functions include those that require heavy-load operation processes. Accordingly, the functions that can be processed by the client 103 may vary depending on the operation processing capability of hardware that executes the software.

In a first embodiment that is described from this point on, the software functions of the engagement value processing system 101 are assumed, mainly assuming hardware having a relatively rich operation processing capability (resources), such as a personal computer. In contrast, in the engagement value processing system 101 of a second embodiment described below, a description is given of software functions, assuming hardware having a poor operation processing capability, which is also called a poor-resource apparatus, such as a wireless mobile terminal or an embedded microcomputer.

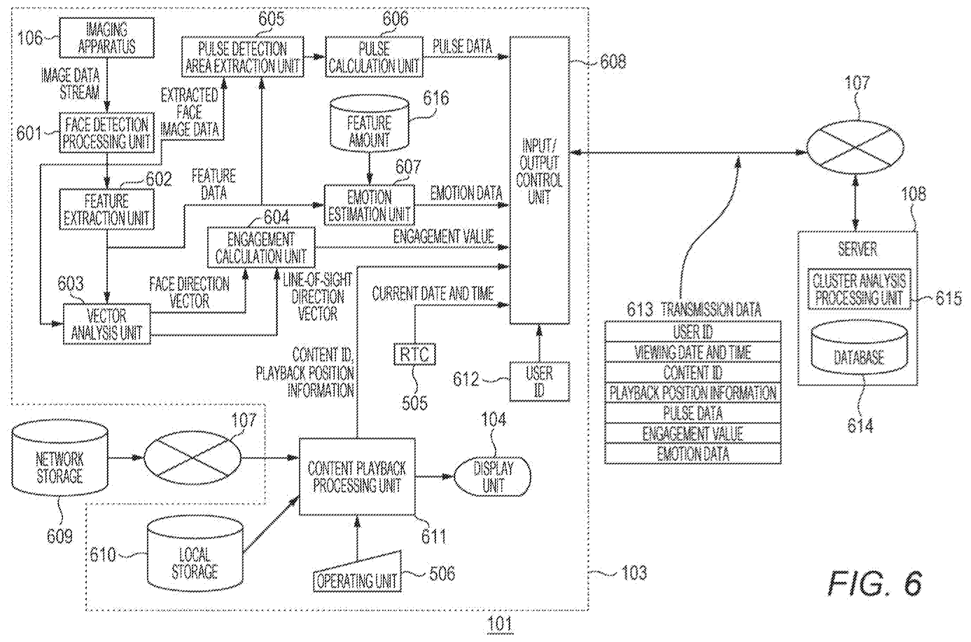

FIG. 6 is a block diagram illustrating the software functions of the engagement value processing system 101 according to the first embodiment of the present invention.

An image data stream obtained by capturing the face of the user 102 who is viewing the content 105 with the imaging apparatus 106 is supplied to a face detection processing unit 601. The image data stream may be temporarily stored in the nonvolatile storage 504 or the like and the subsequent processes may be performed after the playback of the content 105.

The face detection processing unit 601 interprets the image data stream outputted from the imaging apparatus 106 as consecutive still images on the time axis, and detects the presence of the face of the user 102 in each piece of the image data of the consecutive still images on the time axis, using a known algorithm such as the Viola-Jones method, and then outputs extracted face image data obtained by extracting only the face of the user 102.

The extracted face image data outputted by the face detection processing unit 601 is supplied to a feature extraction unit 602.

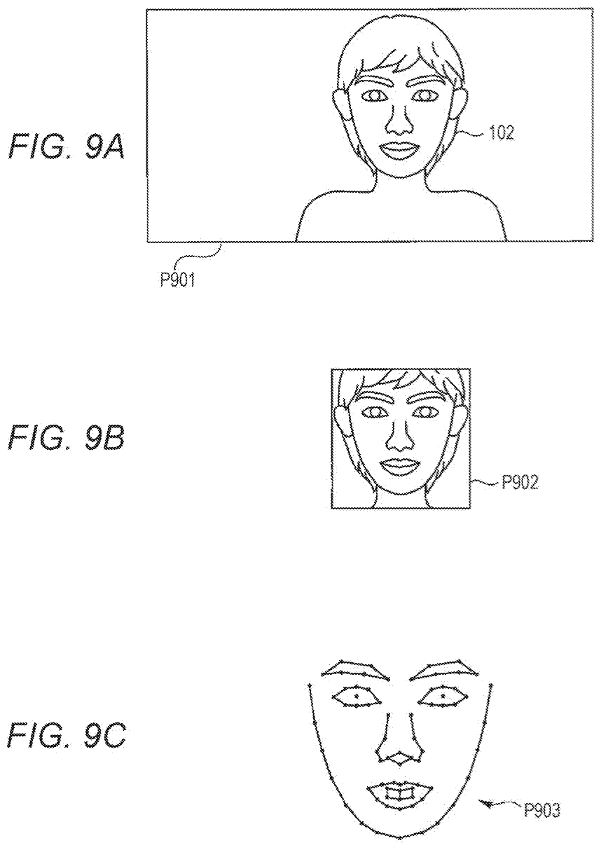

The feature extraction unit 602 performs a process such as a polygon analysis on an image of the face of the user 102 included in the extracted face image data. Feature data including features of the face indicating the contours of the entire face, eyebrows, eyes, nose, mouth, and the like, and the pupils of the user 102 is generated. The details of the feature data are described below in FIGS. 9A to 9C.

The feature data outputted by the feature extraction unit 602 is outputted at predetermined time intervals (a sampling rate) such as 100 msec, according to the operation processing capability of the CPU 501 of the client 103.

The feature data outputted by the feature extraction unit 602 and the extracted face image data outputted by the face detection processing unit 601 are supplied to a vector analysis unit 603.

The vector analysis unit 603 generates a vector indicating the direction of the face of the user 102 (hereinafter the “face direction vector”) at a predetermined sampling rate from feature data based on two consecutive pieces of the extracted face image data as in the feature extraction unit 602.

Moreover, the vector analysis unit 603 uses the feature data based on the two consecutive pieces of the extracted face image data and image data of an eye part of the user 102 cut out from the extracted face image data on the basis of the feature data to generate a vector indicating the direction of the line of sight (hereinafter the “line-of-sight direction vector”) on the face of the user 102 at a predetermined sampling rate as in the feature extraction unit 602.

The face direction vector and the line-of-sight direction vector, which are outputted by the vector analysis unit 603, are supplied to an engagement calculation unit 604. The engagement calculation unit 604 calculates an engagement value from the face direction vector and the line-of-sight direction vector.

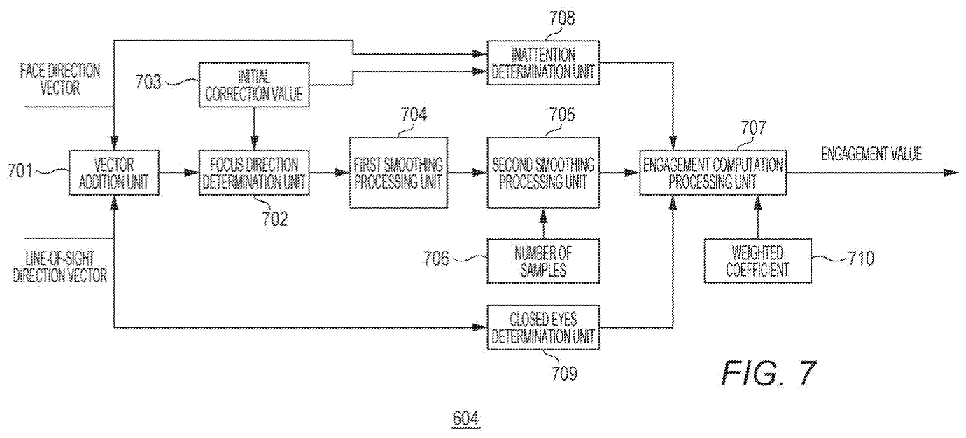

FIG. 7 is a functional block diagram of the engagement calculation unit 604.

The face direction vector and the line-of-sight direction vector, which are outputted by the vector analysis unit 603, are inputted into a vector addition unit 701. The vector addition unit 701 adds the face direction vector and the line-of-sight direction vector to calculate a focus direction vector. The focus direction vector is a vector indicating where in a three-dimensional space including the display unit 104 where the content is being displayed and the imaging apparatus 106 the user 102 is focusing attention.

The focus direction vector calculated by the vector addition unit 701 is inputted into a focus direction determination unit 702. The focus direction determination unit 702 outputs a binary focus direction determination result that determines whether or not the focus direction vector pointing at a target on which the user 102 is focusing attention points at the display unit 104.

If the imaging apparatus 106 is installed in a place away from the vicinity of the display unit 104, a correction is made to the determination process of the focus direction determination unit 702, using an initial correction value 703 stored in the nonvolatile storage 504. Information on the directions of the face and line of sight of the user 102, as viewed from the imaging apparatus 106, of when the face and line of sight of the user 102 point correctly at the display unit 104 is stored in advance in the initial correction value 703 in the nonvolatile storage 504 to detect whether or not the face and line of sight of the user 102 are pointing correctly at the display unit 104.

The binary focus direction determination result outputted by the focus direction determination unit 702 is inputted into a first smoothing processing unit 704. External perturbations caused by noise included in the feature data generated by the feature extraction unit 602 often occur in the focus direction determination result outputted by the focus direction determination unit 702. Hence, the influence of noise is suppressed by the first smoothing processing unit 704 to obtain a “live engagement value” indicating a state that is very close to the behavior of the user 102.

The first smoothing processing unit 704 calculates, for example, a moving average of several samples including the current focus direction determination result, and outputs a live engagement value.

The live engagement value outputted by the first smoothing processing unit 704 is inputted into a second smoothing processing unit 705. The second smoothing processing unit 705 performs a smoothing process on the inputted live engagement values on the basis of the previously specified number of samples 706, and outputs a “basic engagement value,” For example, if “5” is described in the number of samples 706, a moving average of five live engagement values is calculated. Moreover, in the smoothing process, another algorithm such as a weighted moving average or an exponentially weighted moving average may be used. The number of samples 706 and the algorithm for the smoothing process are appropriately set in accordance with an application to which the engagement value processing system 101 according to the embodiments of the present invention is applied.

The basic engagement value outputted by the second smoothing processing unit 705 is inputted into an engagement computation processing unit 707.

On the other hand, the face direction vector is also inputted into an inattention determination unit 708. The inattention determination unit 708 generates a binary inattention determination result that determines whether or not the face direction vector indicating the direction of the face of the user 102 points at the display unit 104. The inattention determination results are counted with two built-in counters in accordance with the sampling rate of the face direction vector and the line-of-sight direction vector, which are outputted by the vector analysis unit 603.

A first counter counts determination results that the user 102 is looking away, and a second counter counts determination results that the user 102 is not looking away. The first counter is reset when the second counter reaches a predetermined count value. The second counter is reset when the first counter reaches a predetermined count value. The logical values of the first and second counters are outputted as the determination results indicating whether or not the user 102 is looking away.

Moreover, a plurality of the first counters is provided according to the direction and accordingly it is also possible to be configured in such a manner that, for example, taking notes at hand is not determined looking away, according to the application.

Moreover, the line-of-sight direction vector is also inputted into a closed eyes determination unit 709. The closed eyes determination unit 709 generates a binary closed eyes determination result that determines whether or not the line-of-sight direction vector indicating the direction of the line of sight of the user 102 has been able to be detected.

Although described below in FIG. 9C, the line-of-sight direction vector can be detected in a state where the eyes of the user 102 are open. In other words, if the eyes of the user 102 are closed, the line-of-sight direction vector cannot be detected. Hence, the closed eyes determination unit 709 generates a binary closed eyes determination result indicating whether or not the eyes of the user 102 are closed. The closed eyes determination results are counted with two built-in counters in accordance with the sampling rate of the face direction vector and the line-of-sight direction vector, which are outputted by the vector analysis unit 603.

A first counter counts determination results that the eyes of the user 102 are closed, and a second counter counts determination results that the eyes of the user 102 are open (are not closed). The first counter is reset when the second counter reaches a predetermined count value. The second counter is reset when the first counter reaches a predetermined count value. The logical values of the first and second counters are outputted as the determination results indicating whether or not the eyes of the user 102 are closed.

The basic engagement value outputted by the second smoothing processing unit 705, the inattention determination result outputted by the inattention determination unit 708, and the closed eyes determination result outputted by the closed eyes determination unit 709 are inputted into the engagement computation processing unit 707.

The engagement computation processing unit 707 multiplies the basic engagement value, the inattention determination result, and the closed eyes determination result by a weighted coefficient 710 in accordance with the application and then adds them to output the final engagement value.

The number of samples 706 and the weighted coefficient 710 are adjusted to enable the engagement value processing system 101 to support various applications. For example, if the number of samples 706 is set at “0”, and both of the weighted coefficients 710 for the inattention determination unit 708 and the closed eyes determination unit 709 are set at “0”, the live engagement itself outputted by the first smoothing processing unit 704 is outputted as the engagement value as it is from the engagement computation processing unit 707.

Especially, the second smoothing processing unit 705 can also be disabled by the setting of the number of samples 706. Hence, it is possible to consider the first smoothing processing unit 704 and the second smoothing processing unit 705 to be a single smoothing processing unit in a broader concept.

The description of the software functions of the engagement value processing system 101 is continued, returning to FIG. 6.

The extracted face image data outputted by the face detection processing unit 601 and the feature data outputted by the feature extraction unit 602 are also supplied to a pulse detection area extraction unit 605.

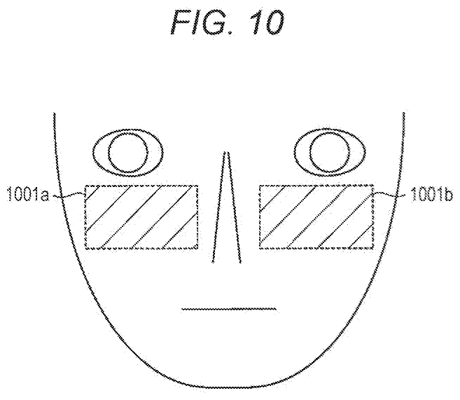

The pulse detection area extraction unit 605 cuts out image data corresponding part of the face of the user 102 on the basis of the extracted face image data outputted from the face detection processing unit 601 and the feature data outputted by the feature extraction unit 602, and outputs the obtained partial image data to a pulse calculation unit 606. Although the details are described below in FIG. 10, the pulse detection area extraction unit 605 cuts out image data, setting areas corresponding to the cheekbones immediately below the eyes within the face of the user 102 as areas for detecting a pulse. The lip, slightly above the glabella, near the cheekbone, and the like are considered as the area for detecting a pulse. However, in the embodiment, a description is given using a case of near the cheekbone having a low possibility that the skin is hidden by a mustache, a beard, and hair and is blocked from view. Various applications are considered to a method for determining a pulse detection area. For example, the lip and slightly above the glabella are also acceptable. Furthermore, a method is also acceptable in which it is configured in such a manner that a plurality of candidate areas such as the lip/immediately above the glabella/near the cheekbone can be analyzed, and the candidates are narrowed down sequentially, setting the next candidate (for example, immediately above the glabella) if the lip is hidden by a mustache/beard, then the candidate (near the cheekbone) after next if the next candidate is also hidden, to determine an appropriate cutting area.

The pulse calculation unit 606 extracts a green component from the partial image data generated by the pulse detection area extraction unit 605 and obtains an average value of brightness per pixel. The pulse of the user 102 is detected, using the changes of the average value with, for example, the short-time Fourier transform described in Patent Document 2 or the like, or the discrete wavelet transform described in Patent Document 3 or the like. The pulse calculation unit 606 of the embodiment is configured in such a manner as to obtain an average value of brightness per pixel. However, the mode or median may be adopted other than an average value.

It is known that hemoglobin included in the blood has characteristics that absorb green light. A known pulse oximeter uses this hemoglobin characteristic, applies green light to the skin, detects reflected light, and detects a pulse on the basis of changes in intensity. The pulse calculation unit 606 is the same on the point of using the hemoglobin characteristic, but is different from the pulse oximeter on the point that data being the basis for detection is image data.

The feature data outputted by the feature extraction unit 602 is also supplied to an emotion estimation unit 607.

The emotion estimation unit 607 refers to a feature amount 616 for the feature data generated by the feature extraction unit 602, and estimates how the expression on the face of the user 102 has changed from the usual facial expression, that is, the emotion of the user 102, using, for example, a supervised learning algorithm such as Bayesian inference or support-vector machines.

As illustrated in FIG. 6, the engagement value of the user 102, the emotion data indicating the emotion of the user 102, and the pulse data indicating the pulse of the user 102, which are obtained from the image data stream obtained from the imaging apparatus 106, are supplied to an input/output control unit 608.

On the other hand, the user 102 is viewing the predetermined content 105 displayed on the display unit 104. The content 105 is supplied from a network storage 609 through the Internet 107, or from a local storage 610, to a content playback processing unit 611. The content playback processing unit 611 plays back the content 105 in accordance with operation information of the operating unit 506 and displays the content 105 on the display unit 104. Moreover, the content playback processing unit 611 outputs, to the input/output control unit 608, a content ID that uniquely identifies the content 105 and playback position information indicating the playback position of the content 105.

Here, the content of the playback position information of the content 105 is different depending on the type of the content 105, and corresponds to playback time information if the content 105 is, for example, moving image data, or corresponds to information that segments the content 105, such as a “page”, “scene number”, “chapter”, or “section,” if the content 105 is data or a program such as a presentation material or a game.

The content ID and the playback position information are supplied from the content playback processing unit 611 to the input/output control unit 608. Furthermore, in addition to these pieces of information, current date and time information at the time of viewing the content, that is, viewing date and time information, which is outputted from the RTC 505, and a user ID 612 stored in the nonvolatile storage 504 or the like are supplied to the input/output control unit 608. Here, the user ID 612 is information that uniquely identifies the user 102, but is preferable to be an anonymous ID created on the basis of, for example, a random number, which is used for known banner advertising from the viewpoint of protecting personal information of the user 102.

The input/output control unit 608 receives the user ID 612, the viewing date and time, the content ID, the playback position information, the pulse data, the engagement value, and the emotion data, and configures transmission data 613. The transmission data 613 is uniquely identified from the user ID 612, and is accumulated in a database 614 of the server 108. At this point in time, the database 614 is provided with an unillustrated table having a user ID field, a viewing date and time field, a content ID field, a playback position information field, a pulse data field, an engagement value field, and an emotion data field. The transmission data 613 is accumulated in this table.

The transmission data 613 outputted by the input/output control unit 608 may be temporarily stored in the RAM 503 or the nonvolatile storage 504, and transmitted to the server 108 after a lossless data compression process is performed thereon. The data processing function of, for example, a cluster analysis processing unit 615 in the server 108 does no need to be simultaneous with the playback of the content 105 in most cases. Therefore, for example, the data obtained by compressing the transmission data 613 may be uploaded to the server 108 after the user 102 finishes viewing the content 105.

The server 108 can also acquire even pulses and emotions of when many anonymous users 102 view the content 105, in addition to engagement values of the playback position information, and accumulate them in the database 614. As the number of the users 102 increases, and as the number of the contents 105 increases, the data of the database 614 increases its use-value as big data suitable for a statistical analysis process of, for example, the cluster analysis processing unit 615.

### Second Embodiment: Software Functions of Engagement Value Processing System 801

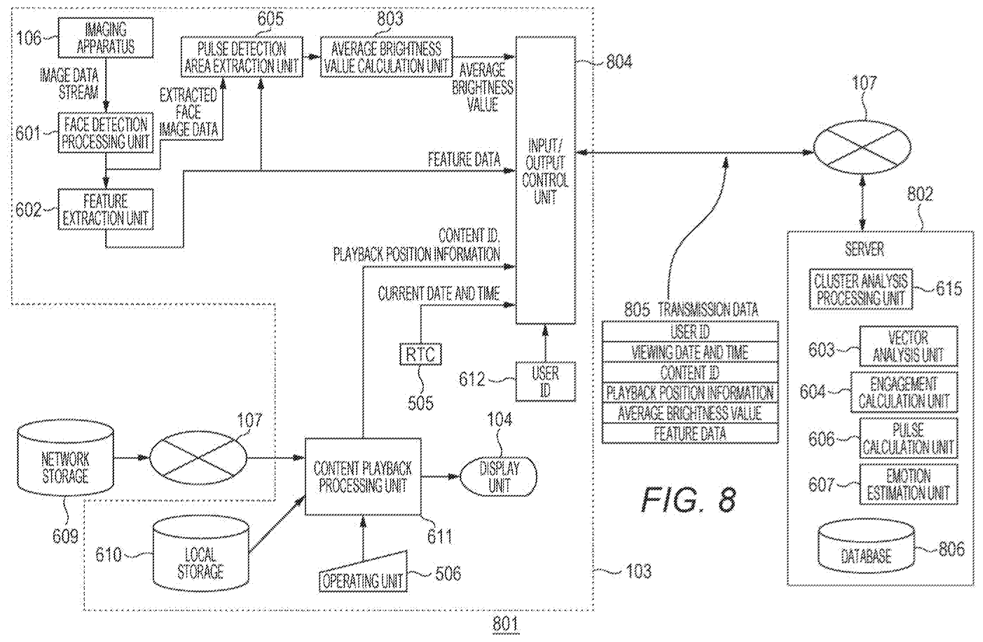

FIG. 8 is a block diagram illustrating the software functions of an engagement value processing system 801 according to the second embodiment of the present invention.

The engagement value processing system 801 illustrated in FIG. 8 according to the second embodiment of the present invention is different from the engagement value processing system 101 illustrated in FIG. 6 according to the first embodiment of the present invention in the following four points:

(1) The vector analysis unit 603, the engagement calculation unit 604, the emotion estimation unit 607, and the pulse calculation unit 606, which are in the client 103, are in a server 802.

(2) The pulse calculation unit 606 is replaced with an average brightness value calculation unit 803 that extracts a green component from partial image data generated by the pulse detection area extraction unit 605, and calculates an average value of brightness per pixel.

(3) The above (1) and (2) allow transmitting an average brightness value instead of pulse data, as transmission data 805 generated by an input/output control unit 804, and transmitting feature data instead of an engagement value and emotion data.

(4) The above (3) allows creating an unillustrated table having a user ID field, a viewing date and time field, a content ID field, a playback position information field, an average brightness value field, and a feature field in a database 806 of the server 802 and accumulating the transmission data 805.

In other words, in the engagement value processing system 801 of the second embodiment, the engagement calculation unit 604, the emotion estimation unit 607, and the pulse calculation unit 606 of heavy load operation processes among the functional blocks existing in the client 103 in the first embodiment have been relocated to the server 802.

The engagement calculation unit 604 requires many matrix operation processes, the emotion estimation unit 607 requires an operation process of a learning algorithm, and the pulse calculation unit 606 requires, for example, the short-time Fourier transform or the discrete wavelet transform. Accordingly, the loads of the operation processes are heavy. Hence, the server 802 having rich computational resources is caused to have these functional blocks (software functions) to execute these operation processes on the server 802. Accordingly, even if the client 103 is a poor-resource apparatus, the engagement value processing system 801 can be realized.

The average brightness value calculation unit 803 is provided on the client 103 side to reduce the data amount through a network.

The user ID 612, the viewing date and time, the content ID, the playback position information, the pulse data, the engagement value, and the emotion data are also eventually accumulated in the database 806 of the server 802 of the second embodiment as in the database 614 of the first embodiment.

Moreover, it is necessary to previously associate information on, for example, the size of the display unit 104 of the client 103 and the installation position of the imaging apparatus 106, the information being referred to by the engagement calculation unit 604 in an operation process, with the user ID 612, transmit the information from the client 103 to the server 802, and hold the information in the database 806 of the server 802.

As described above, the engagement calculation unit 604, the emotion estimation unit 607, and the pulse calculation unit 606 in the client 103 in the engagement value processing system 101 according to the first embodiment of the present invention have been relocated to the server 802 in the engagement value processing system 801 according to the second embodiment of the present invention. Hence, as illustrated in FIG. 8, the transmission data 805 outputted from the input/output control unit 804 is configured including the user ID 612, the viewing date and time, the content ID, the playback position information, the average brightness value, and the feature data. The feature data is data referred to by the engagement calculation unit 604 and the emotion estimation unit 607. The average brightness value is data referred to by the pulse calculation unit 606.

### [Regarding Feature Data]

The operations of the face detection processing unit 601, the feature extraction unit 602, and the vector analysis unit 603 are described below.

FIG. 9A is a schematic diagram illustrating an example of an image data stream outputted from the imaging apparatus 106. FIG. 9B is a schematic diagram illustrating an example of extracted face image data outputted by the face detection processing unit 601. FIG. 9C is a schematic diagram illustrating an example of feature data outputted by the feature extraction unit 602.

Firstly, an image data stream including the user 102 is outputted in real time from the imaging apparatus 106. This is image data P901 of FIG. 9A.

Next, the face detection processing unit 601 uses a known algorithm such as the Viola-Jones method and detects the presence of the face of the user 102 from the image data P901 outputted from the imaging apparatus 106. Extracted face image data obtained by extracting only the face of the user 102 is outputted. This is extracted face image data P902 of FIG. 9B.

The feature extraction unit 602 then performs a process such as a polygon analysis on an image of the face of the user 102 included in the extracted face image data P902. Feature data including features of the face indicating the contours of the entire face, eyebrows, eyes, nose, mouse, and the like, and the pupils of the user 102 is then generated. This is feature data P903 of FIG. 9C. The feature data P903 is configured by an aggregate of features including coordinate information in a two-dimensional space.

If two sets of two-dimensional feature data are acquired at different timings on the time axis, a displacement between the sets of the feature data is caused by the face of the user 102 moving slightly. The direction of the face of the user 102 can be calculated on the basis of the displacement. This is the face direction vector.

Moreover, the locations of the pupils with respect to the contours of the eyes can be calculated in the rough direction of the line of sight with respect to the face of the user 102. This is the line-of-sight direction vector.

The vector analysis unit 603 generates the face direction vector and the line-of-sight direction vector from the feature data in the above processes. Next, the vector analysis unit 603 adds the face direction vector and the line-of-sight direction vector. In other words, the face direction vector and the line-of-sight direction vector are added to find which way the user 102 is pointing the face and also the line of sight. Eventually, the focus direction vector indicating where in a three-dimensional space including the display unit 104 and the imaging apparatus 106 the user 102 is focusing attention is calculated. Furthermore, the vector analysis unit 603 also calculates a vector change amount, which is the amount of change on the time axis, of the focus direction vector.

As illustrated in FIG. 9C, points indicating the eye contour parts and the centers of the pupils exist in places corresponding to the eyes of the user 102. The vector analysis unit 603 can detect the line-of-sight direction vector on the basis of the existence of the points indicating the centers of the pupils in the contours. Conversely, if there are not the points indicating the centers of the pupils in the contours, the vector analysis unit 603 cannot detect the line-of-sight direction vector. In other words, when the eyes of the user 102 are closed, the feature extraction unit 602 cannot detect the points indicating the centers of the pupils in the eye contour parts. Accordingly, the vector analysis unit 603 cannot detect the line-of-sight direction vector. The closed eyes determination unit 709 of FIG. 7 detects the state where the eyes of the user 102 are closed on the basis of the presence or absence of the line-of-sight direction vector.

The closed eyes determination process also includes, for example, a method in which an eye image is directly recognized, in addition to the above one, and can be changed as appropriate according to the accuracy required by an application.

### [Regarding Pulse Detection Area]

FIG. 10 is a diagram schematically illustrating areas cut out as partial image data by the pulse detection area extraction unit 605 from image data of the face of the user 102.

Although also described in Patent Document 2, it is necessary to eliminate as many elements irrelevant to the skin color such as the eyes, nostrils, lips, hair, mustache, and beard in the face image data as possible to correctly detect a pulse from the facial skin color Especially the eyes move rapidly, and the eyelids are closed and opened. Accordingly, the brightness changes suddenly in a short time resulting from the presence and absence of the pupils in the image data, which causes adverse effects when an average value of brightness is calculated. Moreover, the presence of hair, a mustache, and a beard inhibits the detection of the skin color greatly although there are variations among individuals.

Considering the above, areas 1001a and 1001b below the eyes are examples of areas that are hardly affected by the presence of the eyes, hair, a mustache, and a beard and allows the relatively stable detection of the skin color as illustrated in FIG. 10.

The engagement value processing system 101 according to the embodiments of the present invention has the function of vectorizing the face of the user 102 and recognizing the face of the user 102. Accordingly, the pulse detection area extraction unit 605 can realize the calculation of the coordinate information on the areas below the eyes from the face features.

### [Regarding Estimation of Emotion]

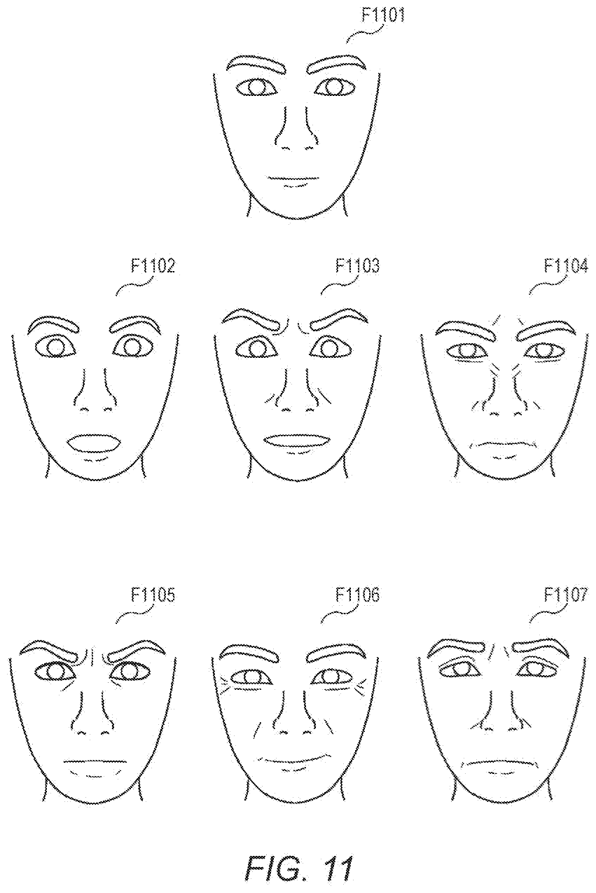

FIG. 11 is a schematic diagram explaining emotion classification performed by the emotion estimation unit 607.

According to Paul Ekman (Paul Ekman), humans who belong to any language area and cultural area have universal emotions. Moreover, the classification of emotions according to Ekman is also called “Ekman's six basic emotions.” A human's facial expression changes with six emotions of surprise (F1102), fear (F1103), disgust (F1104), anger (F1105), happiness (F1106), and sadness (F1107) with respect to a usual neutral face (F1101). A change in the facial expression appears as changes in the facial features. The emotion estimation unit 607 detects relative changes in the facial features on the time axis, and estimates to which emotion the expression on the face of the user 102 at the playback position information or on the viewing date and time of the content 105 belongs, according to Ekman's six basic emotions, using the relative changes.

### Third Embodiment: Hardware Configuration of Engagement Value Processing Apparatus 1201

The engagement value is also useful as information for controlling the playback state of a content.

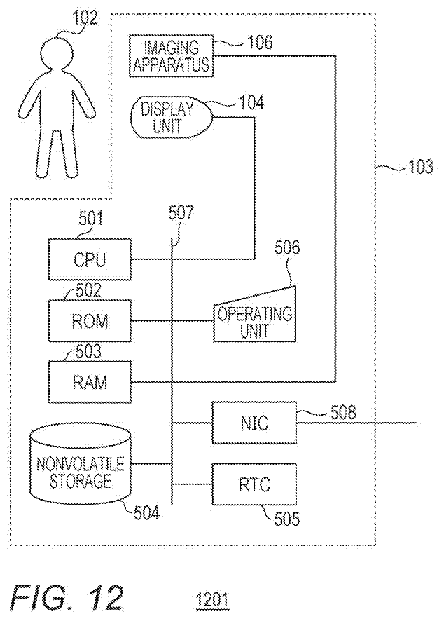

FIG. 12 is a block diagram illustrating the hardware configuration of an engagement value processing apparatus 1201 according to a third embodiment of the present invention.

The hardware configuration of the engagement value processing apparatus 1201 illustrated in FIG. 12 is the same as the client 103 of the engagement value processing system 101 illustrated in FIG. 5 according to the first embodiment of the present invention. Hence, the same reference signs are assigned to the same components and their description is omitted.

The engagement value processing apparatus 1201 has a standalone configuration unlike the engagement value processing system 101 according to the first embodiment of the present invention. However, the standalone configuration is not necessarily required. The calculated engagement value and the like may be uploaded to the server 108 if necessary as in the first embodiment.

### Third Embodiment: Software Functions of Engagement Value Processing Apparatus 1201

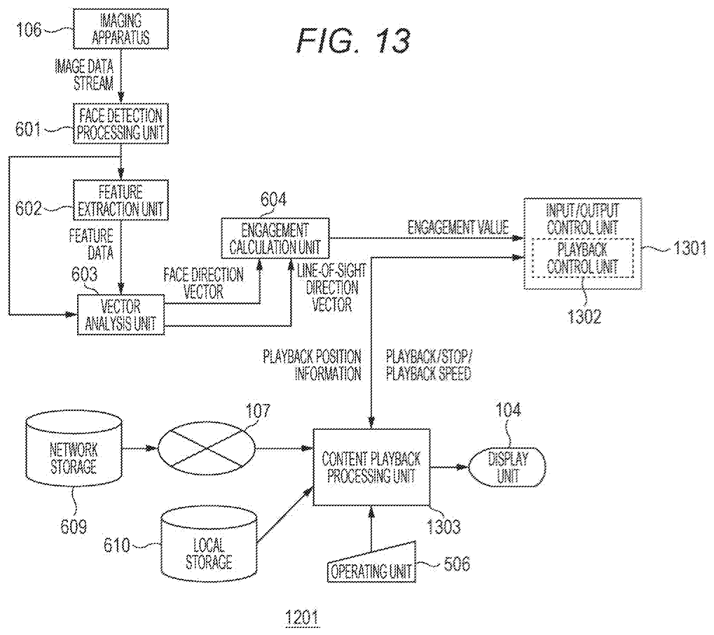

FIG. 13 is a block diagram illustrating the software functions of the engagement value processing apparatus 1201 according to the third embodiment of the present invention. The same reference signs are assigned to the same functional blocks as those of the engagement value processing system 101 illustrated in FIG. 6 according to the first embodiment, in the engagement value processing apparatus 1201 illustrated in FIG. 13, and their description is omitted. The engagement calculation unit 604 of FIG. 13 has the same functions as the engagement calculation unit 604 of the engagement value processing system 101 according to the first embodiment and accordingly is configured by the same functional blocks as the engagement calculation unit 604 illustrated in FIG. 7.

The engagement value processing apparatus 1201 illustrated in FIG. 13 is different from the engagement value processing system 101 illustrated in FIG. 6 according to the first embodiment in including a playback control unit 1302 in an input/output control unit 1301 and a content playback processing unit 1303 executing a change in the playback/stop/playback speed of a content on the basis of control information of the playback control unit 1302.

In other words, the degree of concentration of the user 102 on a content is reflected on the playback speed and playback state of the content.

It is configured in such a manner that in a state where the user 102 is not concentrating on a content (the engagement value is low), the user 102 can view the content without fail by pausing the playback. Conversely, it is configured in such a manner that in a state where the user 102 is concentrating on a content (the engagement value is high), the user 102 can view the content faster by increasing the playback speed.

The playback speed change function is useful especially for learning contents.

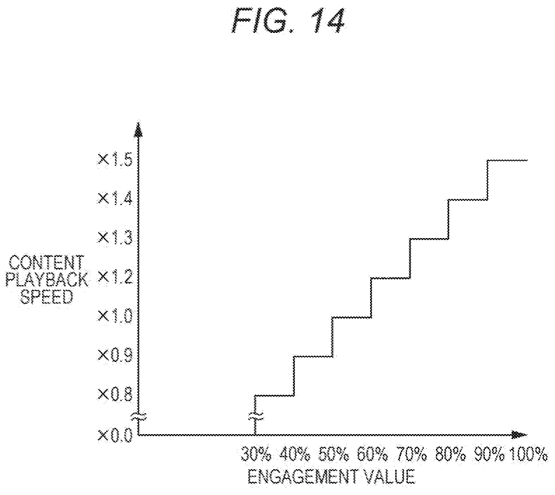

FIG. 14 is a graph illustrating an example of the correspondence between the engagement value and the playback speed of a content generated by control information provided by the playback control unit 1302 to the content playback processing unit 1303. The horizontal axis is the engagement value, and the vertical axis is the content playback speed.

The playback control unit 1302 compares the engagement value outputted from the engagement calculation unit 604 with a plurality of predetermined thresholds, and instructs the content playback processing unit 1303 to play back or pause the content and on the playback speed if the content is played back.

In FIG. 14, as an example, the content playback processing unit 1303 is controlled in such a manner that:
if the engagement value of the user 102 is less than 30%, the playback of the content is paused.
if the engagement value of the user 102 is equal to or greater than 30% and less than 40%, the content is played back at 0.8 times the normal speed.
if the engagement value of the user 102 is equal to or greater than 40% and less than 50%, the content is played back at 0.9 times the normal speed.
if the engagement value of the user 102 is equal to or greater than 50% and less than 60%, the content is played back at 1.0 time the normal speed.
if the engagement value of the user 102 is equal to or greater than 60% and less than 70%, the content is played back at 1.2 times the normal speed.
if the engagement value of the user 102 is equal to or greater than 70% and less than 80%, the content is played back at 1.3 times the normal speed.
if the engagement value of the user 102 is equal to or greater than 80% and less than 90%, the content is played back at 1.4 times the normal speed.
if the engagement value of the user 102 is equal to or greater than 90%, the content is played back at 1.5 times the normal speed.

It is preferable that the user 102 can freely change a threshold and a playback speed, which are set by the playback control unit 1302, using a predetermined GUI (Graphical User Interface).

The embodiments of the present invention disclose the engagement value processing system 101, the engagement value processing system 801, and the engagement value processing apparatus 1201.

The imaging apparatus 106 installed near the display unit 104 captures the face of the user 102 who is viewing the content 105 and outputs an image data stream. Feature data being an aggregate of features of the face is generated by the feature extraction unit 602 from the image data stream. A focus direction vector and a vector change amount are then calculated from the feature data. The engagement calculation unit 604 calculates an engagement value of the user 102 for the content 105 from these pieces of data.

On the other hand, the feature data can also be used to cut out partial image data for detecting a pulse. Furthermore, the feature data can also be used to estimate the emotion of the user 102. Therefore, the engagement value for the content 105, the pulse, and the emotion of the user 102 who is viewing the content 105 can be simultaneously acquired simply by capturing the user 102 with the imaging apparatus 106. It is possible to collectively grasp the act and emotion of the user 102 including not only to what degree the user 102 pays attention but also to what degree the user 102 becomes interested.

Moreover, the engagement value is used to control the playback, pause, and playback speed of a content and accordingly it is possible to expect an improvement in learning effects on the user 102.

Up to this point the embodiments of the present invention have been described. However, the present invention is not limited to the above embodiments, and includes other modifications and application examples without departing from the gist of the present invention described in the claims.

For example, the above-described embodiments are detailed and specific explanations of the configurations of the apparatus and the system for providing an easy-to-understand explanation of the present invention, and are not necessarily limited to those including all the configurations described. Moreover, part of the configurations of a certain embodiment can be replaced with a configuration of another embodiment. Furthermore, a configuration of a certain embodiment can also be added to a configuration of another embodiment. Moreover, another configuration can also be added/removed/replaced to/from/with part of the configurations of each embodiment.

Moreover, part of all of the above configurations, functions, processing units, and the like may be designed as, for example, an integrated circuit to be realized by hardware. Moreover, the above configurations, functions, and the like may be realized by software for causing a processor to interpret and execute a program that realizes each function. Information of a program, a table, a file, or the like that realizes each function can be held in a volatile or nonvolatile storage such as memory, a hard disk, or an SSD (Solid State Drive), or a recording medium such as an IC card or an optical disc.

Moreover, in terms of control lines and information lines, those considered to be necessary for explanation are illustrated. All the control lines and information lines are not necessarily illustrated in terms of a product. In reality, it is may be considered that almost all the configurations are connected to each other.

### DESCRIPTION OF REFERENCE SIGNS

101 Engagement value processing system
102 User
103 Client
104 Display unit
105 Content
106 Imaging apparatus
107 Internet
108 Server
301 LCD display
302 USB web camera
303 Notebook personal computer
304 LCD display
305 web camera
306 Wireless mobile terminal
307 LCD display
308 Selfie front camera
501 CPU
502 ROM
503 RAM
504 Nonvolatile storage
505 RTC
506 Operating unit
507 Bus
508 NIC
511 CPU
512 ROM
513 RAM
514 Nonvolatile storage
515 NIC
516 Bus
601 Face detection processing unit
602 Feature extraction unit
603 Vector analysis unit
604 Engagement calculation unit
605 Pulse detection area extraction unit
606 Pulse calculation unit
607 Emotion estimation unit
608 Input/output control unit
609 Network storage
610 Local storage
611 Content playback processing unit
612 User ID
613 Transmission data
614 Database
615 Cluster analysis processing unit
616 Feature amount
701 Vector addition unit
702 Focus direction determination unit
703 Initial correction value
704 First smoothing processing unit
705 Second smoothing processing unit
706 Number of samples
707 Engagement computation processing unit
708 Inattention determination unit
709 Closed eyes determination unit
710 Weighted coefficient
801 Engagement value processing system
802 Server
803 Average brightness value calculation unit
804 Input/output control unit
805 Transmission data
806 Database
1201 Engagement value processing apparatus
1301 Input/output control unit
1302 Playback control unit
1303 Content playback processing unit

1. An engagement value processing system comprising:
a display unit configured to display a content;
an imaging apparatus installed in a direction of being capable of capturing a face of a user who is watching the display unit;
a face detection processing unit configured to detect the presence of the face of the user from an image data stream outputted from the imaging apparatus and output extracted face image data obtained by extracting the face of the user;
a feature extraction unit configured to output, on the basis of the extracted face image data, feature data being an aggregate of features having coordinate information in a two-dimensional space, the features including a contour of the face of the user;
a vector analysis unit configured to generate, on the basis of the feature data, a face direction vector indicating a direction of the face of the user and a line-of-sight direction vector indicating a direction of the line of sight on the face of the user at a predetermined sampling rate;
an engagement calculation unit configured to calculate an engagement value of the user for the content from the face direction vector and the line-of-sight direction vector; and
a database configured to accumulate a user ID that uniquely identifies the user, a viewing date and time when the user views the content, a content ID that uniquely identifies the content, playback position information indicating a playback position of the content, and the engagement value of the user for the content outputted by the engagement calculation unit.

2. The engagement value processing system according to claim 1, wherein the engagement calculation unit includes:
a vector addition unit configured to add the face direction vector and the line-of-sight direction vector and calculate a focus direction vector indicating where in a three-dimensional space including the display unit where the content is being displayed and the imaging apparatus the user is focusing attention;
a focus direction determination unit configured to output a focus direction determination result that determines whether or not the focus direction vector points at the display unit; and
a smoothing processing unit configured to smooth the focus direction determination results of a predetermined number of samples.

3. The engagement value processing system according to claim 2, wherein the engagement calculation unit further includes:
an inattention determination unit configured to determine whether or not the face direction vector points at the display unit;
a closed eyes determination unit configured to determine whether or not the eyes of the user are closed; and
an engagement computation processing unit configured to multiply a basic engagement value outputted by the smoothing processing unit, an inattention determination result outputted by the inattention determination unit, and a closed eyes determination result outputted by the closed eyes determination unit by a predetermined weighted coefficient and add them.

4. The engagement value processing system according to claim 3, further comprising:
a pulse detection area extraction unit configured to cut out image data corresponding to part of the face of the user, the image data being included in the extracted face image data, on the basis of the feature data, and output the obtained partial image data; and
a pulse calculation unit configured to calculate a pulse of the user from the amount of change on a time axis in brightness of a specific color component in the partial image data, wherein
the database also accumulates pulse data of the user outputted by the pulse calculation unit.

5. The engagement value processing system according to claim 4, further comprising an emotion estimation unit configured to estimate an emotion of the user on the basis of the feature data, wherein the database accumulates emotion data indicating the emotion of the user estimated by the emotion estimation unit.

6. An engagement value processing apparatus comprising:
a content playback processing unit configured to play back a content;
a display unit configured to display the content;
an imaging apparatus installed in a direction of being capable of capturing a face of a user who is watching the display unit;
a face detection processing unit configured to detect the presence of the face of the user from an image data stream outputted from the imaging apparatus and output extracted face image data obtained by extracting the face of the user;
a feature extraction unit configured to output, on the basis of the extracted face image data, feature data being an aggregate of features having coordinate information in a two-dimensional space, the features including a contour of the face of the user;
a vector analysis unit configured to generate, on the basis of the feature data, a face direction vector indicating a direction of the face of the user and a line-of-sight direction vector indicating a direction of the line of sight on the face of the user at a predetermined sampling rate;
an engagement calculation unit configured to calculate an engagement value of the user for the content from the face direction vector and the line-of-sight direction vector; and
a playback control unit configured to control the playback of the content in such a manner that the content is played back at a first playback speed when the engagement value is within a predetermined range of value, the content is played back at a second playback speed faster than the first playback speed when the engagement value is greater than the predetermined range of value, and pause the playback of the content when the engagement value is smaller than the predetermined range of value.

7. The engagement value processing apparatus according to claim 6, wherein the engagement calculation unit includes:
a vector addition unit configured to add the face direction vector and the line-of-sight direction vector and calculate a focus direction vector indicating where in a three-dimensional space including the display unit where the content is being displayed and the imaging apparatus the user is focusing attention;
a focus direction determination unit configured to output a focus direction determination result that determines whether or not the focus direction vector points at the display unit; and
a smoothing processing unit configured to smooth the focus direction determination results of a predetermined number of samples.

8. The engagement value processing apparatus according to claim 7, wherein the engagement calculation unit further includes:
an inattention determination unit configured to determine whether or not the face direction vector points at the display unit;
a closed eyes determination unit configured to determine whether or not the eyes of the user are closed; and
an engagement computation processing unit configured to multiply a basic engagement value outputted by the smoothing processing unit, an inattention determination result outputted by the inattention determination unit, and a closed eyes determination result outputted by the closed eyes determination unit by a predetermined weighted coefficient and add them.
